(19) United States
(12) Patent Application Publication
(10) Pub. No.: US 2025/0286572 A1
(43) Pub. Date: Sep. 11, 2025

(54) COUPLER BYPASS ARCHITECTURE FOR PASS-THROUGH INSERTION LOSS IMPROVEMENT

(71) Applicant: SKYWORKS SOLUTIONS, INC., Irvine, CA (US)

(72) Inventors: Nuttapong Srirattana, Lexington, MA (US); Roman Zbigniew Arkiszewski, Oak Ridge, NC (US); Zijiang Yang, Lexington, MA (US); Rene Rodriguez, Rancho Santa Margarita, CA (US)

(21) Appl. No.: 19/071,837

(22) Filed: Mar. 6, 2025

Related U.S. Application Data
(60) Provisional application No. 63/561,818, filed on Mar. 6, 2024.

(51) Int. Cl. H04B 1/16

(52) U.S. Cl. CPC H04B 1/1638

(57) ABSTRACT

A module is presented for an electronic telecommunications device, the module including: a forward input; a reverse input; a bypass input; an output; a first plurality of switches coupled between the forward input, the reverse input, the bypass input, and the output, the first plurality of switches configured to selectively couple at least one of the forward input, reverse input, or bypass input to the output; and at least one bypass switch configured to selectively couple the bypass input to the output.

### CROSS-REFERENCE TO RELATED APPLICATIONS

This application claims priority under 35 U.S.C. § 119 (e) to U.S. Provisional Patent Application No. 63/561,818, titled COUPLER BYPASS ARCHITECTURE FOR PASS-THROUGH INSERTION LOSS IMPROVEMENT, filed on Mar. 6, 2024, which is hereby incorporated by reference in its entirety for all purposes.

### BACKGROUND

At least one example in accordance with the present disclosure relates generally reducing insertion loss in coupled systems.

### SUMMARY

According to at least one aspect of the present disclosure a module for an electronic telecommunications device is presented, the module comprising: a forward input; a reverse input; a bypass input; an output; a first plurality of switches coupled between the forward input, the reverse input, the bypass input, and the output, the first plurality of switches configured to selectively couple at least one of the forward input, reverse input, or bypass input to the output; and at least one bypass switch configured to selectively couple the bypass input to the output.

In some examples, the first plurality of switches includes a first switch, a second switch, and a third switch, the first switch being coupled to the forward input, reverse input, and bypass input, the second switch being coupled to the first switch and the third switch, and the third switch being coupled between the second switch and the output. In some examples, the module further comprises a plurality of filters coupled to the second switch and the third switch, wherein the second switch is configured to selectively couple the first switch to a filter of the plurality of filters or to the third switch, and the third switch is configured to selectively couple the filter of the plurality of filters or the second switch to the output. In some examples, the module further comprises an attenuator coupled between the plurality of switches and the output, wherein the at least one bypass switch is coupled either between the plurality of switches and the attenuator, or between the attenuator and the output. In some examples, the module further comprises one or more additional outputs and one or more additional attenuators, the one or more additional attenuators being coupled between the plurality of switches and the one or more additional outputs; and one or more additional bypass inputs coupled to the at least one bypass switch, the at least one bypass switch being configured to selectively couple at least one of the one or more additional bypass inputs to the output. In some examples, the at least one bypass switch is further coupled either between the one or more additional attenuators and the plurality of switches or between the one or more additional attenuators and the one or more additional outputs. In some examples, the module further comprises a plurality of impedance networks, each impedance network coupled to a respective attenuator or additional attenuator and to a respective output or additional output. In some examples, the module further comprises an impedance network coupled between the attenuator and the output. In some examples, the module further comprises a second plurality of switches coupled to the output, the second plurality of switches including at least one switch coupled between the output and the at least one bypass switch and at least one switch coupled between the output and the plurality of switches. In some examples, the module further comprises an attenuator coupled either between the second plurality of switches and the output or between the second plurality of switches and the plurality of switches. In some examples, the plurality of switches includes a first switch, a second switch, a third switch, and a fourth switch, the first switch coupled to the second switch, the second switch coupled to the third switch, the third switch coupled to the output and the first switch coupled to at least one of the forward input, reverse input, or bypass input, and the fourth switch coupled to the first switch and to the output. In some examples, the module further comprises a first trace configured to receive a signal; a second trace electromagnetically coupled to the first trace and configured to provide an induced signal responsive to the first trace receiving the signal, wherein the second trace is coupled at a first end to the forward input and at a second end to the reverse input.

According to at least one aspect of the present disclosure a system of connected modules is presented, the system comprising: a first module including a first forward input, a first reverse input, a first bypass input, a first output, a first plurality of switches coupled between the first forward input, first reverse input, and first output, and at least one first bypass switch coupled between the first bypass input and the first output; and a second module including a second forward input, a second reverse input, a second bypass input coupled to the first output, a second output, a second plurality of switches coupled between the second forward input, second reverse input, and second output, and at least one second bypass switch coupled between the second bypass input and the second output.

According to at least one aspect of the present disclosure a system of connected modules is presented, the system comprising: a plurality of modules coupled together in a series, each respective module of the plurality of modules having a forward input, a reverse input, a bypass input, an output, a plurality of switches coupled between the forward input, the reverse input, and the output of the respective module, and at least one bypass switch coupled between the bypass input and the output of the respective module, the output of a first module of the plurality of modules in the series being coupled to the bypass input of a second module of the plurality of modules in the series.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a signal processing module according to an example;

FIG. 2 illustrates a signal processing module according to an example;

FIG. 3 illustrates a plurality of signal processing modules according to an example;

FIG. 4 illustrates a signal processing module according to an example;

FIG. 5 illustrates a signal processing module according to an example;

FIG. 6 illustrates a signal processing module according to an example;

FIG. 7A illustrates a graph of transfer functions of a signal processing module;

FIG. 7B illustrates a graph of transfer functions of a signal processing module;

FIG. 8 illustrates a signal processing module according to an example; and

FIG. 9 illustrates a signal processing module according to an example.

### DETAILED DESCRIPTION

In various electronic applications, including telecommunications, coupled signals may be provided to a given circuit or circuit element (called a “receiver”), such as a feedback receiver, after passing through multiple modules configured to process a signal. Furthermore, each module may be associated with a different antenna (and therefore, a different coupled signal). Thus, a first module may be configured to process a 5 GHz signal, a second module may be configured to process a 6 GHz signal, and so forth.

However, when the modules are coupled together, a given coupled signal may have to pass through multiple modules to reach the receiver. Each module may, therefore, apply some processing to a given signal. For example, a signal originating in a module configured to process a 5 GHz signal may pass through a module configured to process a 6 GHz signal and may undergo adjustments intended for the 6 GHz signal but not intended for the 5 GHz signal. Therefore, modules may include bypass switches that allow a signal to bypass the processing elements (e.g., filters, amplifiers, and so forth) of a given module. By bypassing the processing elements of the module, the signal can be provided to the receiver relatively unchanged compared to if the signal passes through the processing elements of the module.

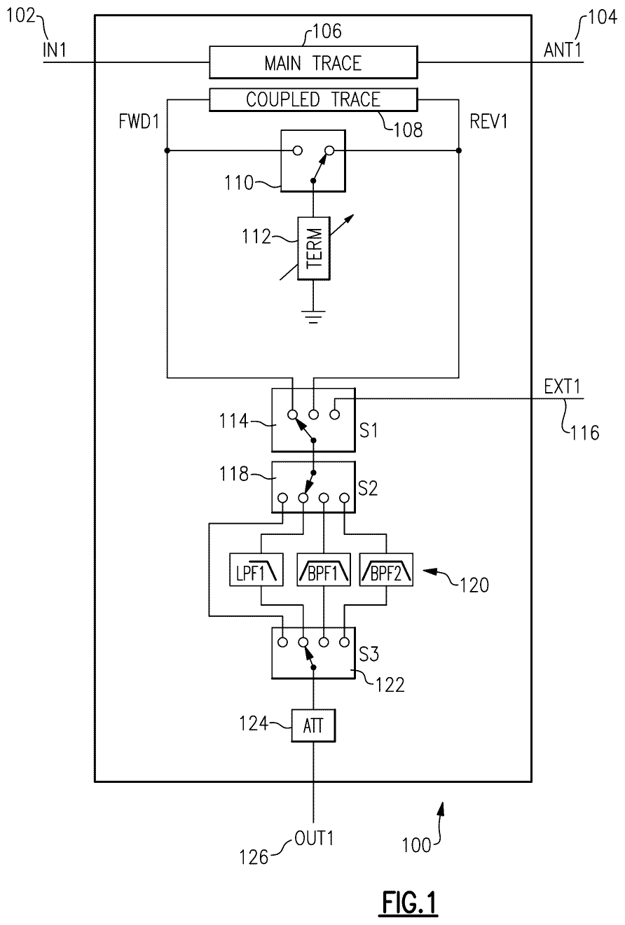

However, each switch introduces insertion loss associated with the switch. Consider the module 100 of FIG. 1. A coupled signal on the coupled trace 108 must, to reach the output 126, pass through the input selection switch 114, the filter selection switch 118, and the output selection switch 122. A signal originating at the second input 116 must pass through the same three switches. Each of these switches (the input selection switch 114, the filter selection switch 118, and the output selection switch 122) will introduce some insertion loss.

Now, suppose multiple modules similar to the module 100 of FIG. 1 are connected in a “daisy-chain,” such that the output (corresponding to output 126) of a first module is connected to the second input (corresponding to second input 116) of a second module, the output of the second module is coupled to the second input of a third module, and so forth, for a total of n modules, where n is any integer. Each module has an input selection switch 114, a filter selection switch 118, and an output selection switch 122. Thus, a signal originating with the first module in the chain must go through n sets of three switches, with each switch causing some insertion loss, before reaching the receiver circuit coupled to the end of the chain. Additionally, the signal may be further attenuated by the attenuation element 124 of each module in the chain (though the attenuation element 124 may be in zero dB gain mode and thus may not necessarily attenuate the signal).

Aspects and elements of the present disclosure relate to techniques and systems for reducing the attenuation of a signal as it is provided to intercoupled modules (such as module 100 of FIG. 1). In some examples, the attenuation that is reduced is the attenuation caused by the switches within the modules (e.g., the insertion loss is reduced). In some examples, the insertion loss is reduced by reducing the number of switches along the path between the signal's origin and the receiver.

Returning to the discussion of FIG. 1, FIG. 1 illustrates a module 100 for use in telecommunications according to an example. A signal received at the input 102 and/or antenna connection 104 passes through the main trace 106, inducing a signal on the coupled trace 108, which is routed via the switches 114, 118, 122 to the output 126.

The module 100 includes a first input 102, an antenna connection 104, a main trace 106, a coupled trace 108, a mode selection switch 110, a termination impedance 112, a source selection switch 114, a filter selection switch 118, a second input 116, a plurality of filtering element 120 (“filters 120”), an output selection switch 122, an attenuation element 124, and an output 126.

The main trace 106 is coupled to the first input 102 and the antenna connection 104. The main trace 106 is further electromagnetically coupled to the coupled trace 108. The coupled trace 108 is coupled to the mode selection switch 110 and the source selection switch 114. The mode selection switch 110 is coupled to the termination impedance 112, and the termination impedance 112 may be coupled to a reference node. The source selection switch 114 is coupled to the filter selection switch 118 and to the second input 116. The filter selection switch 118 is coupled to the filters 120 and to the output selection switch 122. The filters 120 are coupled to the output selection switch 122. The output selection switch 122 is coupled to the attenuation element 124, and the attenuation element 124 is coupled to the output 126.

The first input 102 and antenna connection 104 may be configured to receive a communication signal, such as a sinusoidal voltage and/or current produced by an electrical or magnetic field and/or changes in an electrical or magnetic field. The communication signal may be received via a wired or wireless connection. The communication signal may pass from the antenna connection 104 to the first input 102 or from the first input 102 to the antenna connection 104. In either case, the communication signal may pass through the main trace 106.

The main trace 106 is electromagnetically coupled to the coupled trace 108. When a current and/or voltage is present on the main trace 106, a corresponding voltage and/or current may be induced on the coupled trace 108. The coupled voltage and/or current (“coupled signal”) may be proportionate or otherwise based on the current and/or voltage present on the main trace 106 and/or may be related to changes in the current and/or voltage present on the main trace.

The module 100 may have a forward or reverse mode of operation in some examples. This means that the communication signal that induces the coupled signal may be expressed as a current flowing from the first input 102 to the antenna connection 104, or from the antenna connection 104 to the first input 102. The state of the mode selection switch 110 may change based on the mode of operation. For example, a first connection of the mode selection switch 110 may be coupled to a first end (FWD1) of the coupled trace 108, and a second connection of the mode selection switch 110 may be coupled to a second end (REV1) of the coupled trace 108. The mode selection switch 110 may be configured to selectively couple either the first connection (and therefore the first end of the coupled trace 108) or the second connection (and therefore the second end of the coupled trace 108) to the termination impedance 112. For example, in the forward mode of operation, the mode selection switch 110 may be configured to selectively couple the second connection to the termination impedance 112, and in the reverse mode of operation, the mode selection switch 110 may be configured to selectively couple the first connection to the termination impedance 112. The termination impedance 112 may be variable or constant, and may include resistive and/or reactive elements.

The coupled trace 108 may also be coupled to the source selection switch 114. In some examples, the first end (FWD1) of the coupled trace 108 is coupled to a first connection of the source selection switch 114, the second end (REV1) of the coupled trace 108 is coupled to a second connection of the source selection switch 114, and the second input 116 is coupled to a third connection of the source selection switch 114. The source selection switch 114 is, in turn, configured to selectively couple one of the first connection, second connection, or third connection of the source selection switch 114 to the filter selection switch 118.

The filter selection switch 118 in turn has a plurality of connections, including at least a first connection and a second connection. The filter selection switch 118 is configured to selectively couple the input selection switch 114 to either the output selection switch 122 or a filter of the filters 120. The first connection of the filter selection switch 118 is coupled to a corresponding connection of the output selection switch 122. The second connection of the filter selection switch 118 is coupled to a first filter of the filters 120. Each additional connection of the filter selection switch 122 is coupled to a corresponding filter of the filters 120. For example, a third connection of the filter selection switch 118 may be coupled to a second filter of the filters 120, and a fourth connection of the filter selection switch 118 may be coupled to a third filter of the filters 120.

The filters 120 may include one or more filters configured to condition, attenuate, and/or process the coupled signal. For example, the filters 120 may include one or more low-pass, high-pass, band-pass, band-reject, and/or other filters. In general, the filter selection switch 118 and the output selection switch 122 have at least one connection each corresponding to each respective filter of the filters 120.

The output selection switch 122 is configured to selectively couple the filter selection switch 118 or one filter of the filters 120 to the attenuation element 124. The attenuation element 124 is configured to process (e.g., provide attenuation, gain, or other changes to) the coupled signal. In some examples, the attenuation element 124 may have a 0 dB mode. That is, the attenuation element 124 may be configured to provide no and/or minimal attenuation or gain.

The second input 116 is configured to provide a signal to the input selection switch 114. In some examples, the second input 116 is configured to provide a second coupled signal from (i.e., originating at) a different module.

Thus, in one example of operation, a communication signal on the main trace 106 induces the coupled signal on the coupled trace 108. The input selection switch 114 then selects between the coupled signal or the second coupled signal. Whichever of the two possible coupled signals is selectively coupled to the filter selection switch 118 by the input selection switch 114 is then provided to the filter selection switch 118. The filter selection switch 118 then provides the selected signal to either one of the filters 120 or to the output selection switch 122. The output selection switch 122 may then provide the selected signal to the attenuation element 124 and thence to the output 126.

With reference to the earlier discussion of insertion loss, note that when the second input 116 is selectively coupled (via the input selection switch 114) to the filter selection switch 118, and the filter selection switch 118 is selectively coupling the filter selection switch 118 and the attenuation element 124, the second coupled signal will pass through each of those three switches 114, 118, 122, and may experience insertion loss at each of those switches 114, 118, 122.

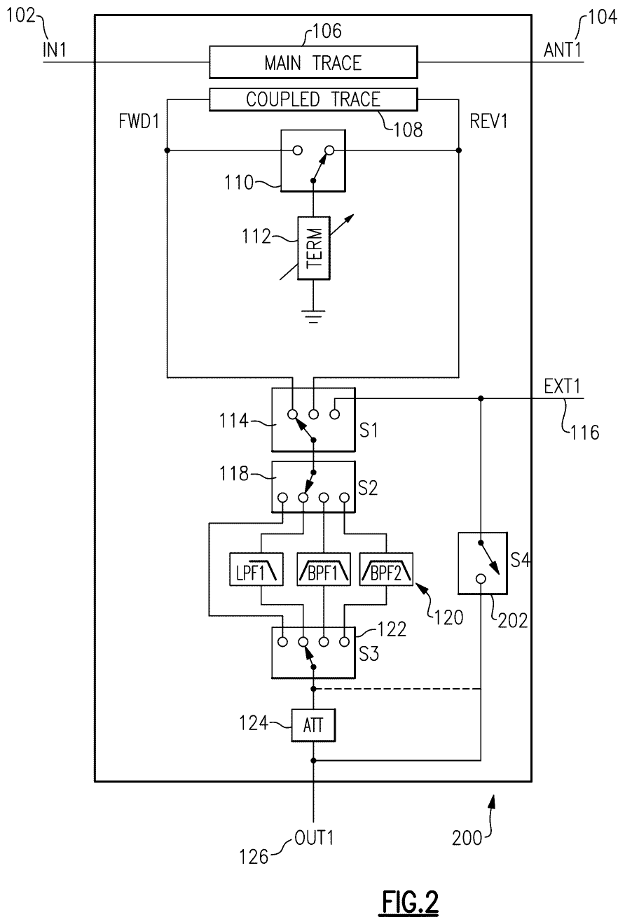

FIG. 2 illustrates a module 200 according to an example. The module 200 is generally similar to the module 100 of FIG. 1, with some differences. A bypass switch 202 has been added. The bypass switch 202 is coupled to the second input 116 and may be coupled directly to the output 126 or may be coupled to the output 126 via the attenuation element 124.

The bypass switch 202 is configured to selectively couple the second input 116 to the output 126 and/or to the attenuation clement 124. In some examples, when the bypass switch 202 is in a closed state (e.g., coupling the second input 116 to the output 126 and/or attenuation element 124), at least one of the input selection switch 114, filter selection switch 118, and/or output selection switch 122 may be in an open state (e.g., decoupled such that no conducting path is available via the respective switch).

When a signal, such as the second coupled signal, is provided via the second input 116, the bypass switch 202 may selectively couple the second input 116 to the attenuation element 124 and/or the output 126, thereby allowing the signal to avoid insertion loss from the input selection switch 114, the filter selection switch 118, and/or the output selection switch 122.

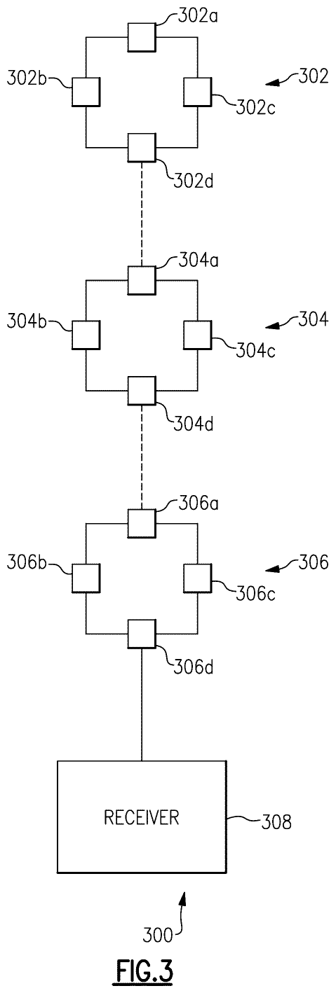

FIG. 3 illustrates a system 300 including a plurality of modules and a receiver according to an example. The system 300 includes a first module 302, a second module 304, a third module 306, and a receiver 308. The system 300 may include one or more additional modules coupled between the second module 304 and the third module 306. The system 300 may include a receiver 308.

The first module 302 includes a first input 302a, a second input 302b, a third input 302c, and an output 302d. The second input 302b may be an input or output depending on the mode of operation of the module 302 (e.g., forward or reverse modes of operation). The third input 302c may be an input or output depending on the mode of operation of the module 302.

The second module 304 includes a first input 304a, a second input 304b, a third input 304c, and an output 304d. The second input 304b may be an input or output depending on the mode of operation of the module 304 (e.g., forward or reverse modes of operation). The third input 304c may be an input or output depending on the mode of operation of the module 304.

The third module 306 includes a first input 306a, a second input 306b, a third input 306c, and an output 306d. The second input 306b may be an input or output depending on the mode of operation of the module 306 (e.g., forward or reverse modes of operation). The third input 306c may be an input or output depending on the mode of operation of the module 306.

Each module 302, 304, 306 includes a bypass switch configured to couple the respective first input of that module to a respective output of that respective module. As illustrated, for example, the first input 304a of the second module 304 is coupled to the output 302d of the first module 302, while the first input 306a of the third module may be coupled to the output 304d of the second module 304. The modules 302, 304, 306 may therefore have bypass switches configured to selectively couple their respective first inputs 302a, 304a, 306a to their respective outputs 302d, 304d, 306d. For example, a bypass switch of the second module 304 may directly couple the first input 304a of the second module 304 to the output 304d of the second module 304, bypassing some or all of the internal circuit elements and/or electronics of the second module 304.

Thus, when a signal originating with the first module 302 is passed to the receiver, the insertion loss experienced by the signal with respect to the second module 304, third module 306, and any intervening modules between the second module 304 and third module 306 may be proportionate to the insertion loss of the bypass switches within those respective modules. For example, if there are n modules with identical bypass switches having insertion loss L, the total insertion loss may be based on and/or proportional to nL.

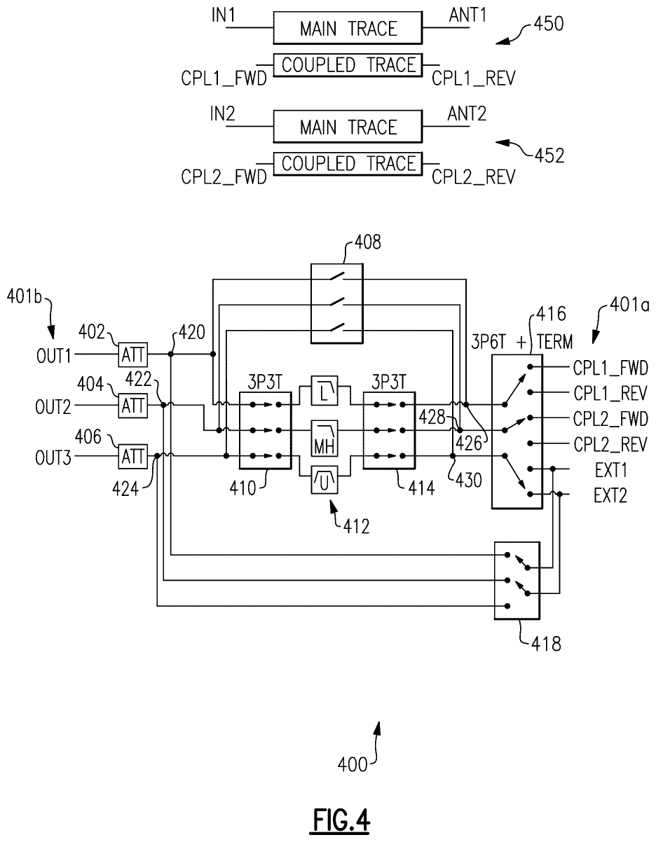

FIG. 4 illustrates a module topology 400 (“module 400”) according to an example. The module 400 is configured to allow a signal to bypass numerous switches when received at one of the inputs. The module 400 includes a plurality of inputs 401a, a plurality of outputs 401b, a first attenuator 402, a second attenuator 404, a third attenuator 406, a first plurality of switches 408, a second plurality of switches 410, a plurality of filters 412, a third plurality of switches 414, a fourth plurality of switches 416, and a fifth plurality of switches 418. FIG. 4 also includes a first node 420, a second node 422, a third node 424, a fourth node 426, a fifth node 428, and a sixth node 430. FIG. 4 also illustrates a first pair of traces 450 and a second pair of traces 452.

The plurality of outputs 401b are coupled to the attenuators 402, 404, 406. In some examples, a first output of the plurality of outputs 401b is coupled to the first attenuator 402, a second output of the plurality of outputs 401b is coupled to the second attenuator 404, and a third output of the plurality of outputs 401b is coupled to the third attenuator 406. The first attenuator 402 is coupled to the first node 420, the second attenuator 404 is coupled to the second node 422, and the third attenuator 406 is coupled to the third node 424.

Respective switches of the first plurality of switches 408 are coupled to one or more of the first node 420, second node 422, third node 424, fourth node 426, fifth node 428, and/or sixth node 430. In some examples, for the first plurality of switches 408, a first switch is coupled at a first connection to the first node 420 and at a second connection to the fourth node 426, a second switch is coupled at a first connection to the second node 422 and at a second connection to the fifth node 428, and a third switch is coupled to the third node 420 at a first connection and to the sixth node 430 at a second connection.

Respective switches of the second plurality of switches 410 are coupled to either the first node 420, second node 422, third node 424, and/or at least one respective filter of the plurality of filters 412. In some examples, for the second plurality of switches 410, a first switch is coupled at a first connection to the first node 420 and at a second connection to a respective filter of the plurality of filters 412, a second switch is coupled at a first connection to the second node 422 and at a second connection to a respective filter of the plurality of filters 412, and a third switch is coupled at a first connection to the third node 424 and at a second connection to a respective filter of the plurality of filters 412.

The plurality of filters 412 is coupled to the second plurality of switches 410 and to the third plurality of switches 414. In some examples, respective filters of the plurality of filters 412 are each coupled to respective switches of the second plurality of switches 410 and to respective switches of the third plurality of switches 414.

Respective switches of the third plurality of switches 414 are coupled to either the fourth node 426, fifth node 428, sixth node 430, and/or at least one respective filter of the plurality of filters 412. In some examples, for the third plurality of switches 414, a first switch is coupled at a first connection to the fourth node 426 and at a second connection to a respective filter of the plurality of filters 412, a second switch is coupled at a first connection to the fifth node 428 and at a second connection to a respective filter of the plurality of filters 412, and a third switch is coupled at a first connection to the sixth node 430 and at a second connection to a respective filter of the plurality of filters 412.

The plurality of inputs 401a are coupled to the fourth plurality of switches 416. In some examples, each switch of the fourth plurality of switches 416 is configured to selectively couple to at least one respective input of the plurality of inputs 401a, and may be configured to be able to selectively couple to any of the inputs of the plurality of inputs 401a. In some examples, a first switch of the fourth plurality of switches 416 is coupled at a first connection to the fourth node 426 and at a second connection to at least one input of the plurality of inputs 401a, a second switch of the fourth plurality of switches 416 is coupled at a first connection to the fifth node 428 and at a second connection to at least one input of the plurality of inputs 401a, and a third switch of the fourth plurality of switches 416 is coupled at a first connection to the sixth node 430 and at a second connection to at least one input of the plurality of inputs 401a.

The fifth plurality of switches 418 is coupled to one or more inputs of the plurality of inputs 401a and is coupled the first node 420, second node 422, and third node 424. The switches of the fifth plurality of switches 418 may be configured to be selectively coupled to any of the first node 420, second node 422, or third node 424. In some examples, the fifth plurality of switches 418 includes a first switch coupled to an input of the plurality of inputs 401a, and a second switch coupled to a different input of the plurality of inputs 401a. In some examples, the inputs to which the fifth plurality of switches 418 are coupled may be coupled to the output of one or more other modules (for example, the output of a module 302b, 304b, 306b of FIG. 3).

The first plurality of switches 408 may be used to provide a bypass path around the second plurality of switches 410, third plurality of switches 414, and the plurality of filters 412. However, a signal arriving at the plurality of inputs 401a that routes through the first plurality of switches 408 goes through at least two switches (a switch of the first plurality of switches 408 and a switch of the fourth plurality of switches 416). By contrast, the fifth plurality of switches 418 can provide a bypass path that includes only one switch (a switch of the fifth plurality of switches 418).

The first pair of traces 450 may include a main trace and a coupled trace, wherein the coupled trace is electromagnetically coupled to the main trace (for example, so that a current and/or voltage on the main trace may induce a current and/or voltage on the coupled trace). These traces may be substantially similar to the main trace 106 and coupled trace 108 of FIGS. 1 and 2. The second pair of traces 452 may include its own respective main trace and coupled trace that are also substantially identical to the main trace 106 and coupled trace 108 of FIGS. 1 and 2.

The coupled traces of the pairs of traces 450, 452 may each have respective “forward” ends and a “reverse” ends corresponding to the mode of operation of a module housing or incorporating the module topology 400. These respective forward and reverse ends of the coupled traces of the pairs of traces 450, 452 may be coupled to respective terminals or connections of the first plurality of inputs 401a.

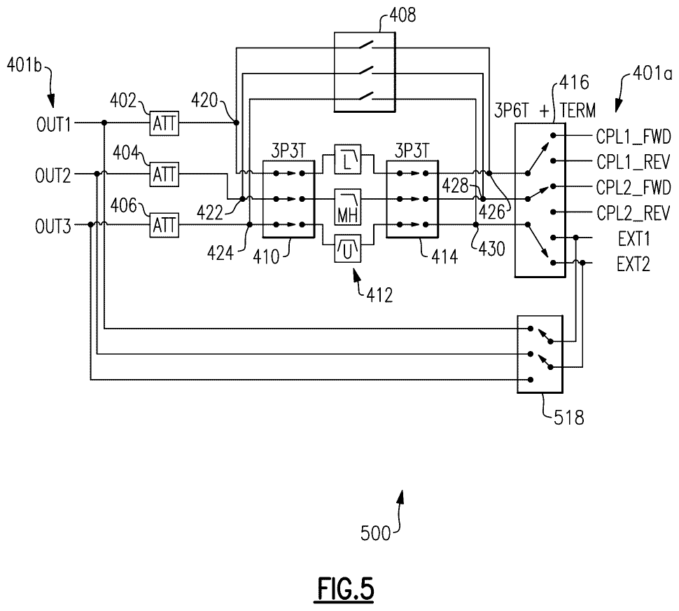

FIG. 5 illustrates a module topology 500 (“module 500”) according to an example. Module 500 is identical to module 400 except that the fifth plurality of switches 418 have been replaced with a plurality of switches 518. The plurality of switches 518 are coupled to at least one input of the plurality of inputs 401a, and are connected to at least one output of the plurality of outputs 401b. In some examples, each switch of the plurality of switches 518 may be selectively coupled to any of the outputs of the plurality of outputs 401b.

The plurality of switches 518 therefore provide a bypass path from the plurality of inputs 401a to the plurality of outputs 401b that avoids the first plurality of switches 408, second plurality of switches 410, plurality of filters 412, third plurality of switches 414, fourth plurality of switches 416, and each attenuator 402, 404, 406. That is, the plurality of switches 518 may directly connect one or more inputs of the plurality of inputs 401a to one or more outputs of the plurality of outputs 401b.

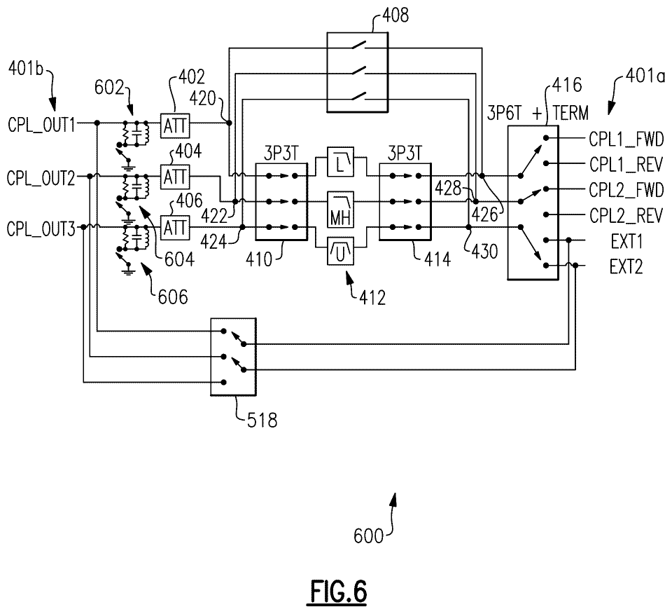

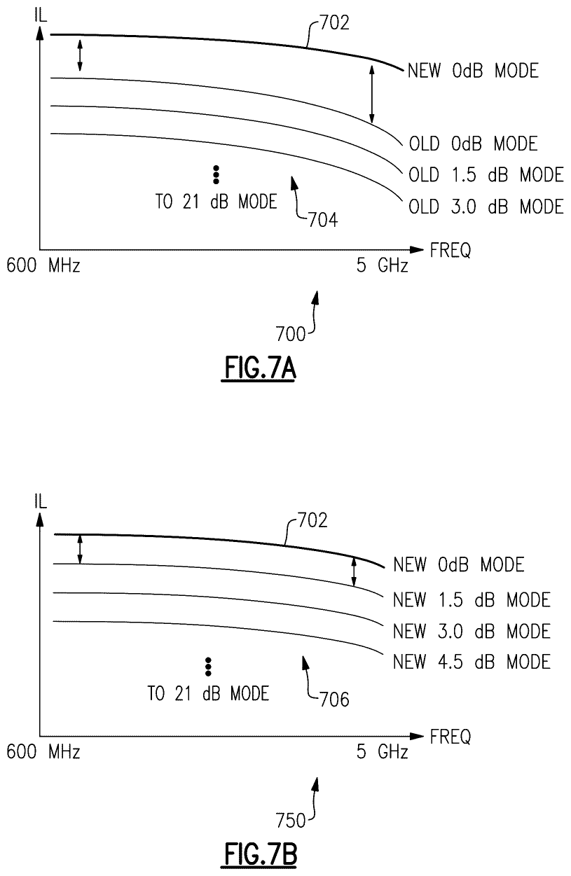

FIG. 6 illustrates a module topology 600 (“module 600”) according to an example. The module 600 is identical to the module 500 except that the module 600 adds a first impedance network 602, a second impedance network 604, and a third impedance network 606. The impedance networks 602, 604, 606 flatten attenuation over frequency, as will be explained with respect to FIG. 7.

The first impedance network 602 is coupled to a first output of the plurality of outputs 401b and switchably coupled to a reference node (or may be coupled to the reference node and be switchably coupled to the first output of the plurality of outputs 401b). The second impedance network 604 is coupled to a second output of the plurality of outputs 401b and switchably coupled to a reference node (or may be coupled to the reference node and be switchably coupled to the second output of the plurality of outputs 401b). The third impedance network 606 is coupled to a third output of the plurality of outputs 401b and switchably coupled to a reference node (or may be coupled to the reference node and be switchably coupled to the third output of the plurality of outputs 401b).

FIG. 7A illustrates a graph 700 of the transfer functions for various operation modes of a module (for example, a module 200 of FIG. 2) according to an example. The graph 700 shows frequency on the x-axis and insertion loss on the y-axis. The graph 700 includes a first trace 702 illustrating the transfer function of a module with a bypass switch (such as module 200 of FIG. 2) in a 0 dB mode compared to a first plurality of traces 704 illustrating the transfer functions of a module without a bypass switch (for example, module 100 of FIG. 1) in a 0 dB mode and various other modes of operation.

As can be seen, the slope of the traces of the first plurality of traces 704 decreases faster, on average, than that of the first trace 702. As a result, as frequency increases, the difference between the first trace 702 and any given trace of the first plurality of traces 704 increases. This is because the bypass route through the bypass switch 202 has different impedance characteristics compared to a route through the source selection switch 114, filter selection switch 118, and output selection switch. 122.

By comparison, FIG. 7B illustrates a graph 750 of the transfer functions for various operation modes of a module (for example, a module 200 of FIG. 2) according to an example. In graph 650, the first trace 702 and the second plurality of traces 706 all correspond to a module with a bypass switch (such as module 200 of FIG. 2).

The addition one or more of the impedance networks 602, 604, 606 in FIG. 6 ensures that the “step” between the various traces is constant or relatively constant (e.g., monotonic). For example, in FIG. 7B, each trace 702, 706 has approximately the same slope and approximately the same rate of change (e.g., decrease) of the slope, thus ensuring that the difference between the first trace 702 and any trace of the second plurality of traces 706 remains approximately equal over frequency.

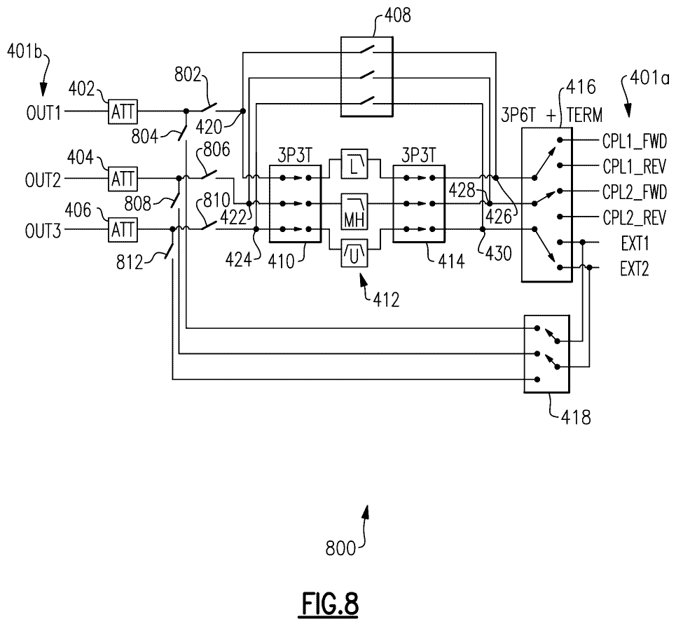

FIG. 8 illustrates a module topology 800 (“module 800”) according to an example. The module 800 is generally identical to module 400 of FIG. 4, except that switches have been interposed between the attenuators 402, 404, 406 and the fifth plurality of switches 418, and between the attenuators 402, 404, 406 and the first node 420, second node 422, and/or third node 424. The switches may reduce off-capacitance of the circuit.

The module 800 includes a first switch 802, second switch 804, third switch 806, fourth switch 808, fifth switch 810, and sixth switch 812.

The first switch 802 is coupled between the first node 420 and the first attenuator 402 and is configured to selectively couple the first attenuator 402 to the first node 420. The second switch 804 is coupled between first node 420 and the fifth plurality of switches 418, and is configured to selectively couple the fifth plurality of switches 418 to the first node 420. The third switch 806 is coupled between the second node 422 and the second attenuator 404 and is configured to selectively couple the second attenuator 404 to the second node 422. The fourth switch 808 is coupled between second node 422 and the fifth plurality of switches 418, and is configured to selectively couple the fifth plurality of switches 418 to the second node 422. The fifth switch 810 is coupled between the third node 424 and the third attenuator 406 and is configured to selectively couple the third attenuator 406 to the third node 424. The sixth switch 812 is coupled between third node 424 and the fifth plurality of switches 418, and is configured to selectively couple the fifth plurality of switches 418 to the third node 424.

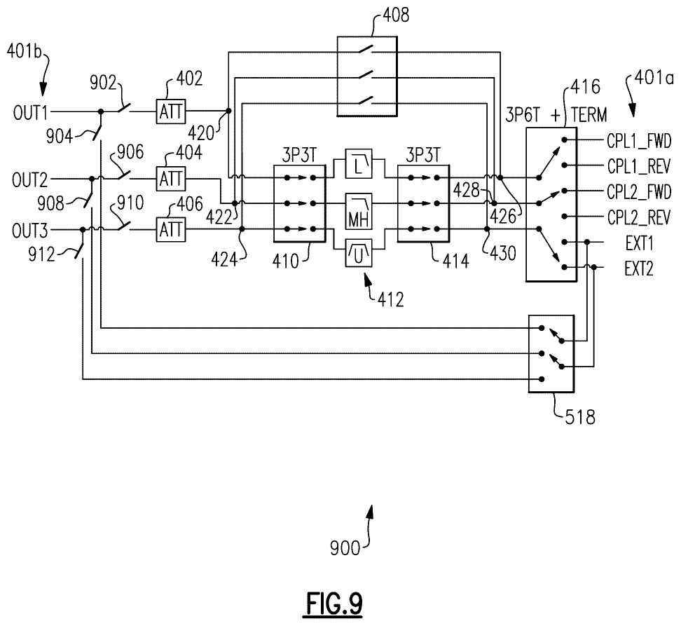

FIG. 9 illustrates a module topology 900 (“module 900”) according to an example. The module 900 is generally identical to module 500 of FIG. 5, except that switches have been interposed between the attenuators 402, 404, 406 and the fifth plurality of switches 418, and between the attenuators 402, 404, 406 and plurality of outputs 401b. The switches may reduce off-capacitance of the circuit.

The module 900 includes a first switch 902, second switch 904, third switch 906, fourth switch 908, fifth switch 910, and sixth switch 912.

The first switch 902 is coupled between the first attenuator 402 and the first output of the plurality of outputs 401b and is configured to selectively couple the first attenuator 402 to the first output. The second switch 904 is coupled between the plurality of switches 518 and the first output of the plurality of outputs 401b and is configured to selectively couple the plurality of switches 518 to the first output. The third switch 906 is coupled between the second attenuator 404 and the second output of the plurality of outputs 401b and is configured to selectively couple the second attenuator 404 to the second output. The fourth switch 908 is coupled between the plurality of switches 518 and the second output of the plurality of outputs 401b and is configured to selectively couple the plurality of switches 518 to the second output. The fifth switch 910 is coupled between the third attenuator 406 and the third output of the plurality of outputs 401b and is configured to selectively couple the third attenuator 406 to the third output. The sixth switch 912 is coupled between the plurality of switches 518 and the third output of the plurality of outputs 401b and is configured to selectively couple the plurality of switches 518 to the third output.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers may execute various operations discussed above. Using data stored in associated memory and/or storage, the controller also executes one or more instructions stored on one or more non-transitory computer-readable media, which the controller may include and/or be coupled to, that may result in manipulated data. In some examples, the controller may include one or more processors or other types of controllers. In one example, the controller is or includes at least one processor. In another example, the controller performs at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A module for an electronic telecommunications device, comprising:
a forward input;
a reverse input;
a bypass input;
an output;
a first plurality of switches coupled between the forward input, the reverse input, the bypass input, and the output, the first plurality of switches configured to selectively couple at least one of the forward input, reverse input, or bypass input to the output; and
at least one bypass switch configured to selectively couple the bypass input to the output.

2. The module of claim 1 wherein the first plurality of switches includes a first switch, a second switch, and a third switch, the first switch being coupled to the forward input, reverse input, and bypass input, the second switch being coupled to the first switch and the third switch, and the third switch being coupled between the second switch and the output.

3. The module of claim 2 further comprising a plurality of filters coupled to the second switch and the third switch, wherein the second switch is configured to selectively couple the first switch to a filter of the plurality of filters or to the third switch, and the third switch is configured to selectively couple the filter of the plurality of filters or the second switch to the output.

4. The module of claim 1 further comprising an attenuator coupled between the plurality of switches and the output, wherein the at least one bypass switch is coupled either between the plurality of switches and the attenuator, or between the attenuator and the output.

5. The module of claim 4 further comprising:
one or more additional outputs and one or more additional attenuators, the one or more additional attenuators being coupled between the plurality of switches and the one or more additional outputs; and
one or more additional bypass inputs coupled to the at least one bypass switch, the at least one bypass switch being configured to selectively couple at least one of the one or more additional bypass inputs to the output.

6. The module of claim 5 wherein the at least one bypass switch is further coupled either between the one or more additional attenuators and the plurality of switches or between the one or more additional attenuators and the one or more additional outputs.

7. The module of claim 5 further comprising a plurality of impedance networks, each impedance network coupled to a respective attenuator or additional attenuator and to a respective output or additional output.

8. The module of claim 4 further comprising an impedance network coupled between the attenuator and the output.

9. The module of claim 1 further comprising a second plurality of switches coupled to the output, the second plurality of switches including at least one switch coupled between the output and the at least one bypass switch and at least one switch coupled between the output and the plurality of switches.

10. The module of claim 9 further comprising an attenuator coupled either between the second plurality of switches and the output or between the second plurality of switches and the plurality of switches.

11. The module of claim 1 wherein the plurality of switches includes a first switch, a second switch, a third switch, and a fourth switch, the first switch coupled to the second switch, the second switch coupled to the third switch, the third switch coupled to the output and the first switch coupled to at least one of the forward input, reverse input, or bypass input, and the fourth switch coupled to the first switch and to the output.

12. The module of claim 1 further comprising:
a first trace configured to receive a signal;
a second trace electromagnetically coupled to the first trace and configured to provide a coupled signal responsive to the first trace receiving the signal, wherein the second trace is coupled at a first end to the forward input and at a second end to the reverse input.

13. The module of claim 12 further comprising:
at least on additional first trace configured to receive a signal; and
at least one additional second trace electromagnetically coupled to the at least one first trace and configured to provide at least one additional coupled signal respective to the at least one first trace receiving at least one additional signal, wherein the at least one second trace is coupled at a first end to at least one additional forward input and at a second end to at least one additional reverse input.

14. A system of connected modules comprising:
a first module including a first forward input, a first reverse input, a first bypass input, a first output, a first plurality of switches coupled between the first forward input, first reverse input, and first output, and at least one first bypass switch coupled between the first bypass input and the first output; and
a second module including a second forward input, a second reverse input, a second bypass input coupled to the first output, a second output, a second plurality of switches coupled between the second forward input, second reverse input, and second output, and at least one second bypass switch coupled between the second bypass input and the second output.

15. The system of claim 14 wherein the first module includes a first impedance network coupled to the first output and the second module includes a second impedance network coupled to the second output.

16. The system of claim 15 wherein the first module and second module are configured to operate in a plurality of modes, including a first mode, a second mode, and a third mode, and wherein a first impedance of the first impedance network and a second impedance of the second impedance network are chosen such that a first transfer function of the system in the first mode changes at approximately a same rate as both a second transfer function of the system in the second mode and a third transfer function of the system in the third mode.

17. The system of claim 14 wherein the first module includes a first attenuator coupled to the first output, and the second module includes a second attenuator coupled to the second output.

18. The system of claim 14 wherein the first module includes a first plurality of filters coupled to the first plurality of switches, and the second module includes a second plurality of filters coupled to the second plurality of switches.

19. The system of claim 18 wherein the first module includes a first auxiliary bypass switch coupled to the first plurality of switches and configured to selectively bypass the first plurality of filters and to selectively couple at least one of the first forward input or first reverse input to the first output.

20. A system of connected modules comprising:
a plurality of modules coupled together in a daisy chain, each respective module of the plurality of modules having a forward input, a reverse input, a bypass input, an output, a plurality of switches coupled between the forward input, the reverse input, and the output of the respective module, and at least one bypass switch coupled between the bypass input and the output of the respective module, the output of a first module of the plurality of modules in the series being coupled to the bypass input of a second module of the plurality of modules in the series.
